(19) United States
(12) Patent Application Publication
(10) Pub. No.: US 2009/0308540 A1
(43) Pub. Date: Dec. 17, 2009

(54) Handheld Accessory Tool and Method for the Application of Adhesive Films

(76) Inventors: Lowell E. Puckett, JR., Cocoa, FL (US); Matthew S. Bobon, Palm Bay, FL (US)

Correspondence Address: Lowell E. Puckett, Jr., 4850 Ancona Rd., Cocoa, FL, 32927, US

(21) Appl. No.: 12/138,295

(22) Filed: Jun. 12, 2008

(51) Int. Cl. B32B 37/12

(52) U.S. Cl. 156/574; 156/60

(57) ABSTRACT

An accessory tool for the application of adhesive films to substrates. The tool is elongate and thin, and made of a lightweight semi-rigid to rigid material. The tool functions as a linear support for the free edge of the film piece during the application process. The tool improves the ability of a worker to hold a film piece taut at a level above the substrate. Use of the tool prevents premature adherence and reduces the formation of bubbles, wrinkles, and other defects commonly encountered during film application. The tool relies on the adhesive nature of the film piece itself in order to make a non-permanent connection between the two. The tool is useful for printing businesses that apply adhesive film pieces, such as graphics, to substrates daily. The invention also relates to an improved manual method for applying adhesive films to substrates.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

The field of the invention pertains to tools that aid in the application of adhesive films to substrates. The invention also relates to a manual method for applying an adhesive film piece to a substrate more easily, quickly, and accurately.

2. Prior Art

Various types of adhesive films for covering, altering, or decorating surfaces have been used for many years. Wallpaper, window tint, and vehicle wraps are examples. In the printing business, adhesive films are used for posters, signs, stickers, and other end products for the general purpose of advertising or displaying text and graphic content. Those skilled in the art also refer to the application of adhesive films as “laying” or “mounting”. A printing business uses various types of adhesive films such as vinyls, photographic papers, pre-masks, and overlaminates. Substrates for mounting include polyvinyl chloride (PVC, such as Sintra®), aluminum composite (such as Signabond®), foam core board (such as Gatorboard®), and heavyweight papers.

The sticky nature of adhesive films makes application to substrates difficult, slow, and tedious. Common problems include the formation of bubbles and wrinkles, and stretching or ripping of the film. Any of these defects may lead to an unsatisfactory product that is not sellable, in which case the film must be reprinted and mounting attempted again. To alleviate the burden of mounting adhesive films, printing businesses have had to employ experienced and thoroughly trained personnel, or utilize a second person during mounting. Even with a second set of hands, mounting is still difficult, slow, and tedious, and errors can still occur.

When a single person mounts a small- to medium-sized adhesive film piece, a hinge method may be used. The hinge method does not require any sophisticated equipment and is typically done by hand. Mounting can be accomplished by a wet or dry method, depending on the specific film and substrate used, or on personal preference. Most instructions for mounting adhesive films require only three basic tools: masking tape, a squeegee, and a knife. Materials for the wet method are the same, with the addition of a spray bottle containing soapy water. A reference for the method of mounting an adhesive film piece is U.S. Pat. No. 5,888,332 by Ciriello. This patent describes the application of a surface cover to a snowboard via the wet method, and lists a squeegee, a razor blade, and a spray bottle as the required tools. The wet method, although it decreases the chance of application mistakes, poses other problems such as a messy, wet, and humid working environment and some degree of safety hazard.

The currently accepted hinge method of mounting involves positioning an intact film piece (adhesive film with its protective backing) upon the substrate and securing the film in place using a strip of masking tape along one outer edge, or along the midpoint of the film. Then, the protective backing is peeled and cut away using a razor blade, which exposes the sticky adhesive. The worker uses one hand to hold the free edge of the film away from (above) the substrate to prevent it from adhering prematurely. With the other hand, the worker uses a squeegee to apply downward pressure to the film starting from the center of the hinge and working away and outward. The pressure causes the adhesive to adhere to the substrate. As the film is laid down with the squeegee, the hand holding the free edge of the film slowly lowers.

Herein lies the first problem encountered with this manual method. The hand and fingers are positioned at the center of the film's free edge, supporting one small surface area only, and leaving the corners free and floppy. If the worker is not careful and does not hold the film high enough away from the substrate, the freely hanging corners may accidentally adhere prematurely. If the film is not held taut, the body of the film may also sag and adhere prematurely. Premature adhesion often leads to damage to the film and/or the substrate, and the worker must start over again.

A second worker may be employed in the mounting process, especially with larger film pieces, so that each worker holds an opposite corner of the film's free edge. This two-person method provides added support along the edge of the film so the corners do not hang. However, two separate independent forces are applying a pulling force to the film. This may cause the film to be applied crookedly, with wrinkles or bubbles, or cause stretching of the film at the corners. Stretched film does not lay flat properly, and distorts the printed graphic.

The mounting of adhesives to substrates is not a skill learned by books, but rather by trial and error, and by advice from other professionals in the industry. Recent books on the subject of mounting techniques cover a broad range of topics, and do not describe the subtleties of the manual method of mounting adhesives in detail. On the contrary, there are widespread Internet websites with instructions for mounting adhesive films. Although the Internet is portrayed as an unregulated source of information, the fact that more practical instructions were found here than in any referenced book or U.S. patent serves as a testament to the self-taught or apprenticeship nature of adhesive film application. The following Internet quotes describe steps in the mounting process where extra diligence is required, or where problems are typically encountered.

“Do not let the entire graphic fall onto the intended surface.” (www.signspecialist.com)

“CAUTION! Do not let the exposed graphic TOUCH the target surface. The graphic face is very tacky and will tightly stick to the surface. If the placement is not correct, removing the graphic for repositioning will be very difficult (and maybe impossible) without causing damage to the vinyl . . . Large graphics are best applied with help from another person to hold vinyl (at the corners of the pre-mask) up off from glass ahead of the squeegee.”(www.pactfour.com)

“While still holding the hinged graphic away from the intended surface (For large graphics, use another person to help hold the graphic), using the squeegee and starting from the top, begin to put the graphic to the intended surface . . . Do not let the entire graphic fall onto the intended surface.” (www.letterspdq.com)

“It is possible to apply these large graphics alone (it is done all the time by experienced pros), however it is much easier if you have a second set of hands to help with positioning the film during the application process . . . Again, it is possible to apply a graphic of this size with just one person, but it is definitely easier with two . . . Applying full vehicle wraps may not be for everyone. This is a skill that requires a lot of patience and is a skill that is developed through time and practice.” (www.signindustry.com)

“You should also maintain tension by firmly holding the bottom of the graphic. On very large graphics, more than one pair of hands may be essential.” (www.absolutegraphix.co.uk)

There are many types of squeegees, rollers, and similar tools available to assist with the application of adhesive films to substrates. U.S. Pat. No. 6,962,741 B2 by Bogman and U.S. Pat. No. 7,225,848 B2 by Williams are examples of squeegees. These tools are successful in achieving the goal of pressing a film to adhere to a substrate. However, there is a void in the market of any product assisting with the second, equally tedious aspect of mounting film; that is, physical support along the full length of the free edge, and the prevention of low-hanging, floppy corners. The current practice of handling adhesive film during mounting is to use the fingers of one hand. This is a learned skill, requiring a “fine touch” and a certain degree of intuition. Printing businesses providing mounting services must utilize experienced, highly trained personnel demanding higher pay. Still, this method leads too often to unsatisfactory, defectively mounted products.

There are other examples in the prior art addressing the need to improve upon the manual method of mounting adhesive films. One example is U.S. Pat. No. 7,182,117 B2 by Abe and Nakayama. This patent describes an adhesive film dispenser with guide panels, resulting in controlled and consistent positioning during mounting. However, this device is specifically intended for long, narrow substrates such as handrails, and would not be able to accommodate the varying sizes of film pieces continuously encountered at a printing or sign business. Another example is U.S. Pat. No. 7,213,631 B1 by Brewer and Bunch. This device is a handheld tool that maintains straightness and tautness of decorative border paper during application, and turns a two-person job into a single-person job that can be completed more quickly. However, the device is not versatile enough to be applicable to the everyday mounting of the adhesive films encountered across other industries such as posters, signs, window tint, and vehicle graphics.

### BRIEF SUMMARY OF THE INVENTION

A need therefore exists for an accessory tool aiding in the application of adhesive films to substrates. The present embodiment of the invention is a simple elongate handheld tool made of a generally thin, lightweight, and semi-rigid or rigid material. The tool is positioned along the free edge of the film and serves as a linear support during application. The tool relies on the adhesive nature of the film piece itself in order to make a non-permanent connection to it. The tool can be manufactured at various lengths or with length-altering ability, so as to correspond with the typical dimensions of adhesive film pieces mounted by workers in the printing business. The tool is shaped so as to provide an optimal gripping surface for the hand.

The object of the invention is to simplify and speed the method by which a single person mounts adhesive films to substrates. It is another object of the invention to provide physical support along the entire length of the film's free edge during the mounting process. It stabilizes the film, which is pliable and floppy by nature, along a greater surface area than allowed by the fingers of one hand. It is another object of the invention to hold film taut during mounting in order to eliminate low-hanging, floppy corners, and to minimize sagging of the film: factors which lead to premature adherence and ruined products that cannot be sold. It is another object of the invention to aid in the production of straight and smoothly mounted products, free of wrinkles, bubbles, and other defects. In these ways, the invention reduces the amount of materials wasted in failed mountings and the reprints needed to replace them. It is still another object of the invention to provide an interface between the hand and the film, preventing the transfer of dirt and oils to the final product. The aforementioned advantages, which the invention provides, were never before recognized by those skilled in the art of mounting adhesive films.

A further object of the invention is to turn a two-person job into a single-person job, thereby saving businesses the money required for a second worker. Along the same lines, it is an object of the invention to allow a single person to apply larger sized film pieces independently, thereby increasing the total output of a single worker and the business as a whole. It is another object of the invention to allow a less experienced, minimally trained person collecting a lower salary to apply adhesive film, rather than a highly trained, experienced person demanding a higher salary. In circumstances where the film piece is large and requires two workers, it is an object of the invention to improve upon the currently accepted method by preventing stretching of the film at the corners where it is held. Finally, it is an object of the invention to replace the wet mounting method with a cleaner and safer dry mounting method in applicable situations. These and other objects of the invention will be apparent from the foregoing description.

### BRIEF DESCRIPTION OF THE SEVERAL VIEWS OF THE DRAWING

FIG. 1 illustrates a perspective view of the embodiment looking from the lower edge.

FIG. 2 illustrates a perspective view of the embodiment looking from the upper edge.

FIG. 3 illustrates the current method of mounting adhesive films by hand using only a squeegee.

FIG. 4 illustrates a new method of mounting adhesive films using both a squeegee and the embodiment.

FIG. 5 illustrates a perspective view of a second embodiment having an angular shaped handle with optional suction cups for window applications.

FIG. 6 illustrates a perspective view of a third embodiment having a tapered shape with longitudinal finger grips.

FIG. 7 illustrates a perspective view of a fourth embodiment having interconnectivity ability and telescoping ability.

### DRAWINGS—REFERENCE NUMERALS

10 first embodiment of tool
12 top surface
14 bottom surface
16 side edge
18 straight lower edge
20 curved upper edge
22 adhesive film piece
24 substrate
26 squeegee
28 masking tape hinge
30 top peripheral edge of film piece
32 side peripheral edge of film piece
34 left hand
36 free edge of film piece
38 right hand
40 midpoint of hinge
42 corner of film piece
44 sagging of film piece
46 overlap of film piece and tool
48 second embodiment of tool
50 angular handle
52 textured surface
53 suction cups
54 third embodiment of tool
56 tapered shape
58 longitudinal finger grip
60 fourth embodiment of tool
62 means for interlocking
64 means for telescoping

### DETAILED DESCRIPTION OF THE INVENTION

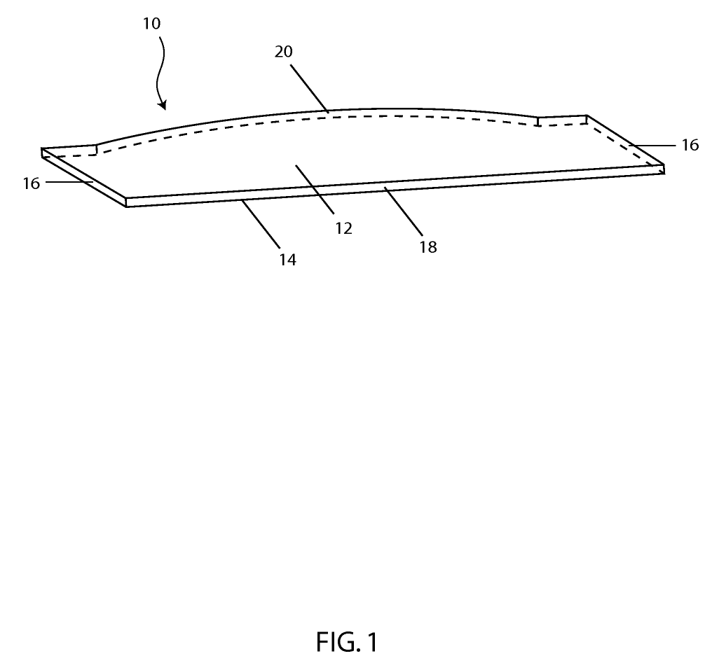

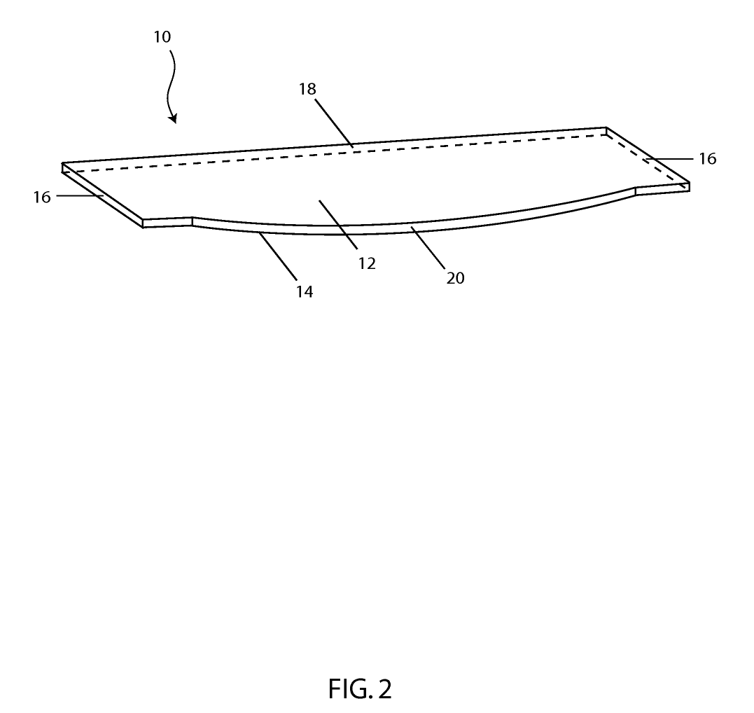

One embodiment of the tool is illustrated in FIG. 1 (looking from the lower edge 18) and FIG. 2 (looking from the upper edge 20). The tool 10 is generally elongate and thin in shape. The tool 10 has a top surface 12, a bottom surface 14, two side edges 16, a straight lower edge 18, and a curved upper edge 20. The purpose of the curved upper edge 20 is to provide a comfortable conformation for manual handling, as well as to provide ornamentation. The tool 10 may be constructed of a variety of lightweight semi-rigid to rigid materials including plastic (such as nylon), metal (such as aluminum), PVC, wood, rubber, or a combination of materials. Presently, we contemplate that the tool 10 is made of closed-cell PVC (such as Sintra®) with a ⅛″ thickness, as this material is inexpensive, and can be easily die-cut into a simple shape by a computer numerical control (CNC) machine. The tool 10 can be manufactured in various lengths, such as the typical lengths of print media encountered in printing and sign business. Examples are 12″, 16″, 18″, 20″, 24″, and 36″.

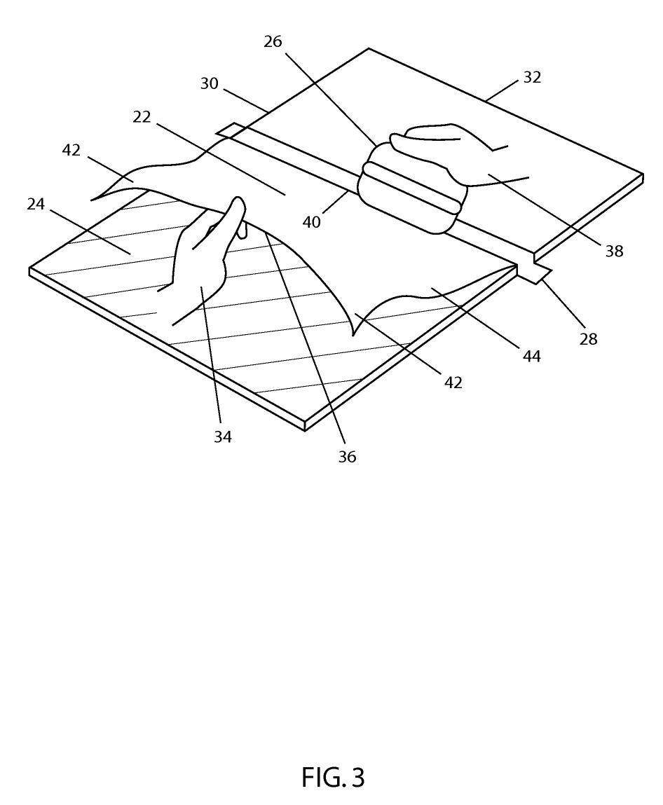

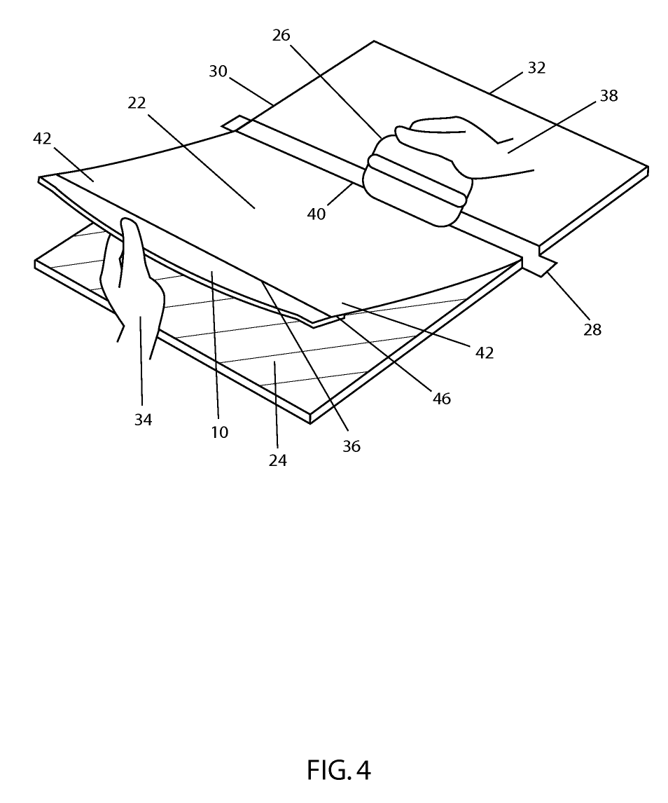

### Operation—FIGS. 3 and 4

FIG. 3 illustrates the current method by which a single person applies a piece of adhesive film 22 to a substrate 24. The current method calls for three tools only: a squeegee 26, masking tape 28, and a knife (not shown). A piece of adhesive film 22 (such as a graphic poster) is positioned upon the substrate 24 on which it is to be mounted, and temporarily held in place by a strip of masking tape 28. The masking tape forms a hinge 28 dividing the film piece 22 into two manageable halves. Alternatively, the hinge 28 may be formed along a peripheral edge 30, 32 of the film piece 22, often times depending on size. FIG. 3 assumes that the protective backing (not shown) has already been peeled and cut away from the film 22. At this stage in the mounting process, the worker uses one hand 34 to hold the free edge 36 of the film 22 up and away from the substrate 24 so as to prevent it from adhering prematurely. In the FIG. 3 example, the left hand 34 performs this function. The second (right) hand 38 holds a squeegee 26. Beginning at the midpoint 40 of the hinge 28, the worker uses the squeegee 26 to apply pressure to the film 22, thereby causing adhesion to the substrate 24. As the worker continues the application process toward the free edge 36 of the film 22, the left hand 34 must lower with the progression. Due diligence and concentration must be exerted as it becomes more difficult to maintain the film 22 at an angle above the substrate 24, and to prevent premature adherence, especially by the low-hanging corners 42. Additionally, if proper tautness is not maintained, the body of the film piece 22 may sag 44 and adhere at unwanted locations. Mounting requires the coordinated action of two hands 34, 38, which if not executed properly causes the wrinkles and bubbles commonly encountered in the process.

FIG. 4 illustrates a new method for the application of adhesive film 22 utilizing the present embodiment of the accessory tool 10. The free edge 36 of the film 22 is aligned with the tool 10, the film 22 overlapping 46 the top surface 12 (not shown here, but shown in FIGS. 1 and 2) of the tool 10 by a small, arbitrary amount and pressed to adhere. This action marries the film 22 and the tool 10 together in a non-permanent fashion. In the method shown in FIG. 4, the worker's left hand 34 grips the accessory tool 10, and easily holds the film 22 at a level above the substrate 24. The worker continues squeegee 26 action with the right hand 38. As the end of the mounting process nears, the tool 10 is simply unattached from the film 22, and the remaining un-adhered portion is applied to the substrate 24 using the squeegee 26.

By gripping the tool 10 rather than the film 22 itself, many beneficial functions become apparent. First and foremost, the tool 10 provides linear support along the entire free edge 36 of the film 22, and allows for a uniform pulling force to be exerted upon the film 22. This stabilizing effect also helps to maintain alignment of the film 22 with the substrate 24, rather than being inadvertently guided off course by subtle movements of the hand 34. In addition, the tool 10 maintains tautness of the film 22, thereby eliminating floppy corners 42 and minimizing sagging 44. Using examples from other industries, the tool 10 functions very much like a batten. For example, a thin strip of wood is usually sewn into the hem of a roller window shade to provide evenly distributed support during unwinding. Another example is a boat sail or a theater drop cloth, both of which depend on a rigid strip affixed at one edge to hold them taut. In general, the tool provides a higher level of control to a precarious task, and lends confidence to a self-doubting worker.

When the length of a film piece 22 exceeds the comfortable arm's reach of a single person, application becomes a two-person job. Longer lengths of the tool 10 may be manufactured to assist in such situations. The tool 10 minimizes variations in the forces and movements being exerted by two separate persons upon the free corners 42 of the film, factors causing stretching and distortion. Finally, for both one- and two-person jobs, the tool 10 acts as an interface between the hand 34 and the film 22, thereby preventing the transfer of oils and dirt from the fingers onto the film 22.

The functionality of the tool 10 is dependent upon the adhesive from the film 22 itself providing non-permanent attachment of the two objects 10, 22. Although the tack level of film 22 types is variable, most films 22 will provide substantial tackiness for the tool 10 to function, as only a light pulling force is needed to keep a film piece 22 taut during mounting. The tool 10 need not match the exact length of the film piece 22 being applied. The tool 10 will still perform its full function even if it is slightly longer than the film piece 22. However, if the tool 10 is slightly shorter, the film piece 22 will overhang the edges, causing corners 42 to hang loosely, albeit to a lesser degree than if the tool 10 was not used at all. As the tool 10 length increases, the requirement for rigidity also increases, since the tool 10 will be used to support larger film pieces 22 having greater surface areas and weights.

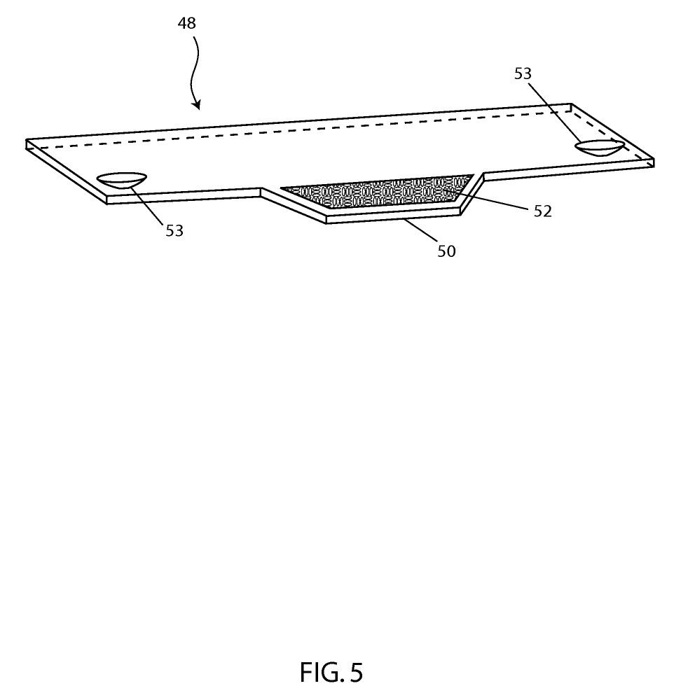

### Alternate Embodiments—FIGS. 5, 6, and 7

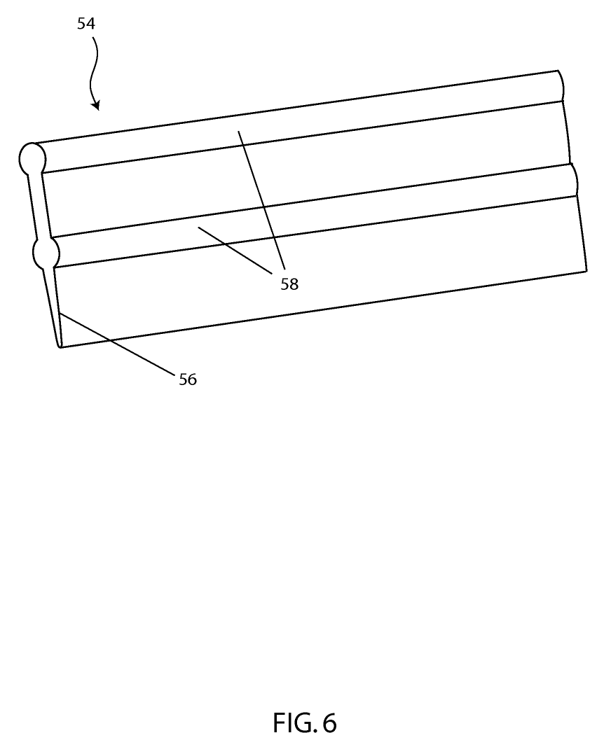

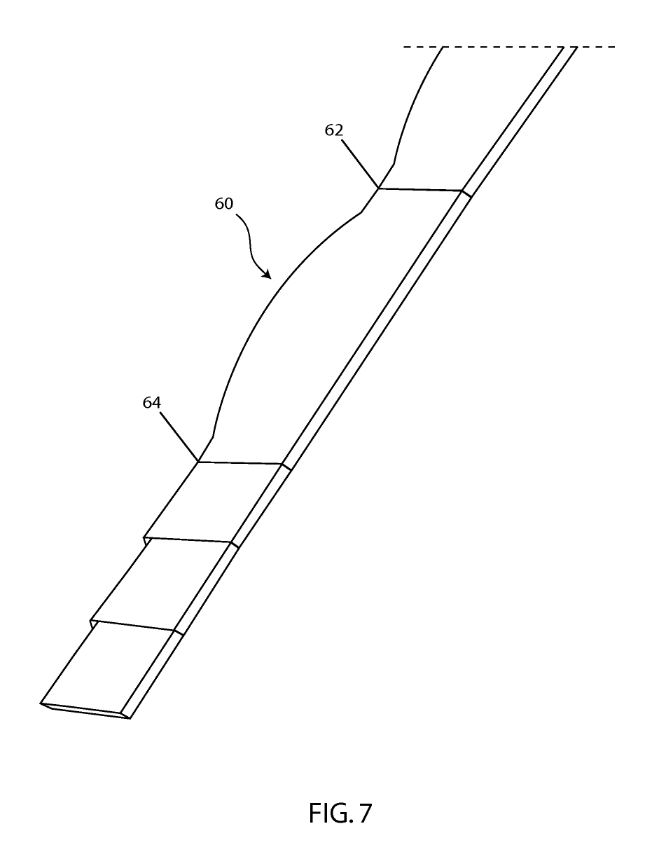

FIG. 5 shows an alternate embodiment 48 with an angular protruding handle 50. The handle 50 may further comprise a textured surface 52, such as raised rubber, to improve gripping by the hand 34 (not shown here, but shown in FIGS. 3 and 4). FIG. 5 also shows the embodiment 48 affixed with suction cups 53, which we presently contemplate to be an optional feature, useful during single-person window applications. Windows, being a vertical substrate, pose the added challenge of gravity, which further confounds handling of the film piece and tools during mounting. Specifically, the suction cups 53 are used to temporarily secure the embodiment 48 (attached to the film's free edge 36, as shown in FIG. 4) to the window, so that both hands are free to complete the next step in the application process, which is to cut away the film's protective backing. FIG. 6 shows yet another embodiment 54 with a tapered shape 56 and raised longitudinal finger grips 58. This embodiment resembles a squeegee 26 (not shown here, but shown in FIGS. 3 and 4), but has a longer length and serves a different purpose. Other shapes and surface textures are possible to optimize hand comfort and grip. However, we contemplate that the portion of the tool constituting the area of overlap 46 (shown in FIG. 4) remains a smooth, texture-free surface for optimal adhesion of the film 22 to the tool 10. FIG. 7 shows a fourth embodiment 60 of the tool, which demonstrates two different means to achieve length variability: end-to-end interlocking ability 62, or telescoping ability 64. Interlocking ability 62 can be achieved by tongue-and-groove or any other joinery method.

### Conclusions, Ramifications, and Scope

The present invention is directed toward an accessory tool used in the application of adhesive films to substrates. The tool is elongate and thin, made of semi-rigid to rigid material. The tool introduces two new steps to the current method of mounting an adhesive film piece to a substrate. The two new steps occur after formation of the masking tape hinge and removal of the protective backing. They are: 1) the free edge of the adhesive film piece is positioned upon the tool and pressed to adhere, resulting in the non-permanent attachment of the film to the tool and 2) the worker uses one hand to grasp the tool and hold the film piece taut at a level above the substrate. The rest of the application continues as normal with a squeegee.

The reader will see that at least one embodiment of the tool provides advantages never before recognized or appreciated in the manual application of adhesive films to substrates in that
it provides linear support along the entire free edge of a film piece during application;
it holds a film piece taut, thereby eliminating low-hanging corners and minimizing sagging, the main factors leading to premature adherence;
it helps maintain straight and accurate application of the film piece while reducing wrinkles, bubbles, and other defects;
it saves the materials often wasted by the error-prone nature of the current method;
it provides an interface between fingers and the film piece, thereby preventing the transfer of dirt and oil;
it allows a single person with less training and skill to apply adhesive films;
it allows a single person to apply adhesive films more quickly;
it turns certain two-person jobs into jobs that can be accomplished by only one person;
it improves stabilization and prevents stretching of the corners when the two-person method of application is employed;
it turns an instinctual and delicate task into a simpler, more routine task;
it provides a clean and effective alternative to wet mounting.

We presently contemplate that the tool be manufactured at a variety of lengths. Also, the tool is simple and inexpensive to manufacture. Therefore, we contemplate that a printing business will purchase several differently sized models of the product to have on hand for various daily mounting tasks. We also contemplate that the tool may be sold in a kit, along with other standard application tools such as the squeegee. Although the description above contains many specificities, these should not be construed as limiting the scope of the embodiment, but as merely providing illustrations of some of the presently preferred embodiments. For example, the tool can have other shapes, such as a paddle-like shape. It can also have gripping features, such as a textured strip along top surface. Another possible ramification is interconnectivity. The tool may be manufactured at one length, with a means to connect multiple tools together to result in a longer tool. Yet another ramification is telescoping ability, so that a single tool may be utilized for a broader size spectrum of film pieces. While the invention is currently contemplated to assist with film application onto flat substrates, it can also assist with film application onto curved surfaces, such as during vehicle wrapping. The tool can be manufactured in a variety of colors and affixed with logos.

Thus, the scope of the invention should be determined by the appended claims and their legal equivalents, rather than by the examples given.

We claim:

1. An accessory tool for the application of adhesive films to substrates comprising: a substantially thin, elongate body having a top surface, a bottom surface, two opposite side edges, a lower edge, and an upper edge.

2. The accessory tool as defined in claim 1, said upper edge having a curved shape.

3. The accessory tool as defined in claim 1, said upper edge having an angular shape.

4. The accessory tool as defined in claim 1, said top surface having a texture.

5. The accessory tool as defined in claim 4, said texture comprising longitudinal finger grips.

6. The accessory tool as defined in claim 1, said elongate body tapering in width approaching said lower edge.

7. The accessory tool as defined in claim 1, said accessory tool being constructed of a semi-rigid material.

8. The accessory tool as defined in claim 7, said semi-rigid material being selected from the group consisting of plastic, nylon, rubber, and PVC.

9. The accessory tool as defined in claim 1, said accessory tool being constructed of a rigid material.

10. The accessory tool as defined in claim 9, said rigid material being selected from the group consisting of metal and wood.

11. The accessory tool as defined in claim 1, said accessory tool being affixed with suction cups.

12. The accessory tool as defined in claim 1, said accessory tool having a means for interlocking with a second accessory tool.

13. The accessory tool as defined in claim 1, said accessory tool having a means for telescoping to increase length.

14. A method for the application of adhesive films to substrates comprising:
(a) providing an accessory tool comprising a substantially thin, elongate body constructed of a lightweight semi-rigid to rigid material having a top surface, a bottom surface, two opposite side edges, a lower edge, and an upper edge;
(b) providing a film piece with a protective backing, a midpoint, and four peripheral edges, said four peripheral edges being a top edge, a bottom edge, and two side edges;
(c) providing a substrate, masking tape, and a squeegee;
(d) forming a masking tape hinge along said midpoint of said film piece, resulting in one of said peripheral edges becoming a free edge;
(e) removing said protective backing from said film piece;
(f) overlapping said free edge of said film piece upon said top surface of said accessory tool and pressing to cause non-permanent adhesion of said film piece to said accessory tool;
(g) holding said accessory tool with one hand thereby holding said film piece above said substrate to prevent said film piece from adhering prematurely;
(h) holding said squeegee with a second hand;
(i) starting from said midpoint of said film piece and pressing with said squeegee to cause adhesion of said film piece to said substrate;
(j) continuing to press said squeegee toward said free edge of said film piece, lowering said hand holding said accessory tool with the progression;
(k) upon nearing said free edge of said film piece, removing said accessory tool, and completing adhesion of said film piece to said substrate using said squeegee.

15. The method of claim 14 wherein said masking tape hinge is formed along one of said peripheral edges of said film piece.
